(19) United States
(12) Patent Application Publication
(10) Pub. No.: US 2026/0370884 A1
(43) Pub. Date: Nov. 19, 2026

(54) CONSTITUENT RECTANGLE AND DISPLAY RECTANGLE SUPPLEMENTAL ENHANCEMENT INFORMATION (SEI) MESSAGES

(71) Applicant: QUALCOMM Incorporated, San Diego, CA (US)

(72) Inventors: Yong He, San Diego, CA (US); Louis Joseph Kerofsky, San Diego, CA (US); Shuai Zhao, Rancho Cordova, CA (US)

(21) Appl. No.: 19/674,758

(22) Filed: May 12, 2026

Related U.S. Application Data
(60) Provisional application No. 63/805,699, filed on May 14, 2025.
(60) Provisional application No. 63/822,660, filed on Jun. 12, 2025.
(60) Provisional application No. 63/882,746, filed on Sep. 16, 2025.

(51) Int. Cl. H04N 19/70; H04N 19/124; H04N 19/176; H04N 19/18; H04N 19/30; H04N 19/46; H04N 19/91

(52) U.S. Cl. CPC H04N 19/70; H04N 19/124; H04N 19/176; H04N 19/18; H04N 19/30; H04N 19/46; H04N 19/91

(57) ABSTRACT

An apparatus for decoding video data is configured to receive, in a bitstream of the video data, a constituent rectangles supplemental enhancement information (SEI) message; receive, in the constituent rectangles SEI message, a first syntax element indicating whether a second syntax element is present in the constituent rectangles SEI message; in response to the first syntax element indicating the second syntax element is present, receive, in the constituent rectangles SEI message, the second syntax element, wherein the second syntax element indicates a layer index of an associated rectangle for a current constituent rectangle; and decode the video data based on the layer index of the associated rectangle.

This application is related to:
U.S. Provisional Patent Application 63/805,699, filed 14 May 2025,
U.S. Provisional Patent Application 63/822,660, filed 12 Jun. 2025,
U.S. Provisional Patent Application 63/882,746, filed 16 Sep. 2025, the entire contents of each being hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by Moving Picture Experts Group (MPEG)-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

This disclosure describes techniques for decoding encoded video data utilizing constituent rectangles supplemental enhancement information messages. A constituent rectangles supplemental enhancement information message enables the composition of multiple rectangular elements within a coded picture. To accurately reconstruct scenes, an encoded bitstream includes various syntax elements providing specific information about the multiple rectangular elements.

During decoding, a video decoder receives the constituent rectangles supplemental enhancement information message containing a first syntax element. The first syntax element indicates whether a second syntax element is present within the constituent rectangles supplemental enhancement information message. Based on the first syntax element indicating presence, the video decoder determines the second syntax element. The second syntax element indicates a layer index of an associated primary rectangle for a current constituent rectangle. A third syntax element subsequently indicates an identifier of the associated primary rectangle.

By signaling the layer index explicitly, the video decoder associates the current constituent rectangle with an associated primary rectangle located in a completely different layer. Such cross-layer association may provide flexibility when reusing rectangle layouts across multiple layers. Furthermore, signaling the layer index reduces identification errors that may occur when different layers reuse identical rectangle identifiers. In situations where the first syntax element indicates absence of the second syntax element, the video decoder infers the layer index of the associated primary rectangle equals a current layer index for the current constituent rectangle, thereby saving signaling overhead. The video decoder ultimately decodes the video data based on the layer index and the identifier of the associated primary rectangle.

According to an example of this disclosure, a method for decoding video data includes: receiving, in a bitstream of the video data, a constituent rectangles supplemental enhancement information (SEI) message; receiving, in the constituent rectangles SEI message, a first syntax element indicating whether a second syntax element is present in the constituent rectangles SEI message; in response to the first syntax element indicating the second syntax element is present, receiving, in the constituent rectangles SEI message, the second syntax element, wherein the second syntax element indicates a layer index of an associated rectangle for a current constituent rectangle; and decoding the video data based on the layer index of the associated rectangle.

According to an example of this disclosure, an apparatus for decoding video data includes: at least one memory; and processing circuitry in communication with the at least one memory, the processing circuitry configured to: receive, in a bitstream of the video data, a constituent rectangles supplemental enhancement information (SEI) message; receive, in the constituent rectangles SEI message, a first syntax element indicating whether a second syntax element is present in the constituent rectangles SEI message; in response to the first syntax element indicating the second syntax element is present, receive, in the constituent rectangles SEI message, the second syntax element, wherein the second syntax element indicates a layer index of an associated rectangle for a current constituent rectangle; and decode the video data based on the layer index of the associated rectangle.

A computer-readable storage medium stores instructions that when executed by one or more processors cause the one or more processors to: receive, in a bitstream of video data, a constituent rectangles supplemental enhancement information (SEI) message; receive, in the constituent rectangles SEI message, a first syntax element indicating whether a second syntax element is present in the constituent rectangles SEI message; in response to the first syntax element indicating the second syntax element is present, receive, in the constituent rectangles SEI message, the second syntax element, wherein the second syntax element indicates a layer index of an associated rectangle for a current constituent rectangle; and decode the video data based on the layer index of the associated rectangle.

According to an example of this disclosure, a device for decoding video data includes: means for receiving, in a bitstream of the video data, a constituent rectangles supplemental enhancement information (SEI) message; means for receiving, in the constituent rectangles SEI message, a first syntax element indicating whether a second syntax element is present in the constituent rectangles SEI message; means for receiving, in the constituent rectangles SEI message, the second syntax element in response to the first syntax element indicating the second syntax element is present, wherein the second syntax element indicates a layer index of an associated rectangle for a current constituent rectangle; and means for decoding the video data based on the layer index of the associated rectangle.

According to an example of this disclosure, a method for encoding video data includes: generating, for a bitstream of the video data, a constituent rectangles supplemental enhancement information (SEI) message; generating, in the constituent rectangles SEI message, a first syntax element indicating whether a second syntax element is present in the constituent rectangles SEI message; in response to the first syntax element indicating the second syntax element is present, generating, in the constituent rectangles SEI message, the second syntax element, wherein the second syntax element indicates a layer index of an associated rectangle for a current constituent rectangle; and encoding the video data based on the layer index of the associated rectangle.

According to an example of this disclosure, an apparatus for encoding video data includes: at least one memory; and processing circuitry in communication with the at least one memory, the processing circuitry configured to: generate, for a bitstream of the video data, a constituent rectangles supplemental enhancement information (SEI) message; generate, in the constituent rectangles SEI message, a first syntax element indicating whether a second syntax element is present in the constituent rectangles SEI message; in response to the first syntax element indicating the second syntax element is present, generate, in the constituent rectangles SEI message, the second syntax element, wherein the second syntax element indicates a layer index of an associated rectangle for a current constituent rectangle; and encode the video data based on the layer index of the associated rectangle.

A computer-readable storage medium stores instructions that when executed by one or more processors cause the one or more processors to: generate, for a bitstream of video data, a constituent rectangles supplemental enhancement information (SEI) message; generate, in the constituent rectangles SEI message, a first syntax element indicating whether a second syntax element is present in the constituent rectangles SEI message; in response to the first syntax element indicating the second syntax element is present, generate, in the constituent rectangles SEI message, the second syntax element, wherein the second syntax element indicates a layer index of an associated rectangle for a current constituent rectangle; and encode the video data based on the layer index of the associated rectangle.

According to an example of this disclosure, a device for encoding video data includes: means for generating, for a bitstream of the video data, a constituent rectangles supplemental enhancement information (SEI) message; means for generating, in the constituent rectangles SEI message, a first syntax element indicating whether a second syntax element is present in the constituent rectangles SEI message; means for generating, in the constituent rectangles SEI message, the second syntax element in response to the first syntax element indicating the second syntax element is present, wherein the second syntax element indicates a layer index of an associated rectangle for a current constituent rectangle; and means for encoding the video data based on the layer index of the associated rectangle.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a flowchart illustrating an example method for generating a constituent rectangles supplemental enhancement information (SEI) message in accordance with the techniques of this disclosure.

FIG. 7 is a flowchart illustrating an example method for processing a constituent rectangles supplemental enhancement information (SEI) message in accordance with the techniques of this disclosure.

### DETAILED DESCRIPTION

Versatile Video Coding (VVC) defines a supplemental enhancement information (SEI) message as a syntax structure with specified semantics that conveys a particular type of information that assists in processes related to decoding, display or other purposes but is not needed by the decoding process in order to determine the values of the samples in decoded pictures. The Versatile supplemental enhancement information (VSEI) standard, that is ITU-T H.274 and ISO/IEC 23002-7, specifies the video usability information (VUI) and some of the SEI messages used with the VVC bitstream. The SEI mechanism enables encoders to include such metadata in the bitstream that is not required for the correct decoding of the sample values of the output pictures but can be used for various other purposes. Encoders can include any number of SEI Network Abstraction Layer (NAL) units in an access unit, and each SEI NAL unit may contain one or more SEI messages. Specifications and systems using VVC may require encoders to generate certain SEI messages or may define specific handling of particular types of received SEI messages.

Existing video coding standards support constituent rectangles to enable the composition of multiple rectangular elements within a coded picture. To associate a current constituent rectangle with a primary rectangle, existing approaches often identify the primary rectangle using a rectangle identifier. However, such existing approaches typically assume the associated primary rectangle resides in the same layer as the current constituent rectangle. This single-layer assumption restricts flexibility, as multi-layer video coding schemes may store the primary rectangle in a completely different layer. Furthermore, referencing only the rectangle identifier creates ambiguity and identification errors when different layers reuse identical rectangle identifiers.

To address these technical challenges, the techniques of this disclosure introduce improved signaling for constituent rectangles supplemental enhancement information messages. A video encoder generates a first syntax element indicating whether a second syntax element is present within the constituent rectangles supplemental enhancement information message. The second syntax element indicates a layer index of an associated primary rectangle for a current constituent rectangle. During decoding, a video decoder receives the first syntax element and, based on the first syntax element indicating presence, determines the layer index of the associated primary rectangle from the second syntax element. The video decoder subsequently receives a third syntax element indicating an identifier of the associated primary rectangle, enabling precise cross-layer referencing.

By explicitly signaling the layer index alongside the rectangle identifier, the disclosed techniques enable video coding devices to accurately associate constituent rectangles across different layers. This cross-layer association may provide flexibility for reusing rectangle layouts across multiple layers without risking identification conflicts. Additionally, when the associated primary rectangle resides in the same layer as the current constituent rectangle, the video encoder configures the first syntax element to indicate the absence of the second syntax element. The video decoder then infers the layer index equals a current layer index, thereby minimizing signaling overhead while maintaining robust multi-layer composition capabilities. The video decoder ultimately decodes the video data based on the layer index and the identifier of the associated primary rectangle.

By decoding the video data based on the layer index of the associated rectangle, the video decoder selectively retrieves the associated primary rectangle from a designated layer within a decoded picture buffer. The selective retrieval avoids searching across all available layers and prevents redundant transmission of the primary rectangle data within the current layer. The targeted retrieval reduces memory bandwidth consumption and processing cycles during the composition of the constituent rectangles. Furthermore, establishing the layer index via the first syntax element and the second syntax element reduces signaling overhead within the bitstream, improving compression efficiency and bandwidth utilization of the video transmission system. The techniques of this disclosure thus improve the underlying functioning of the video decoder and the video encoder.

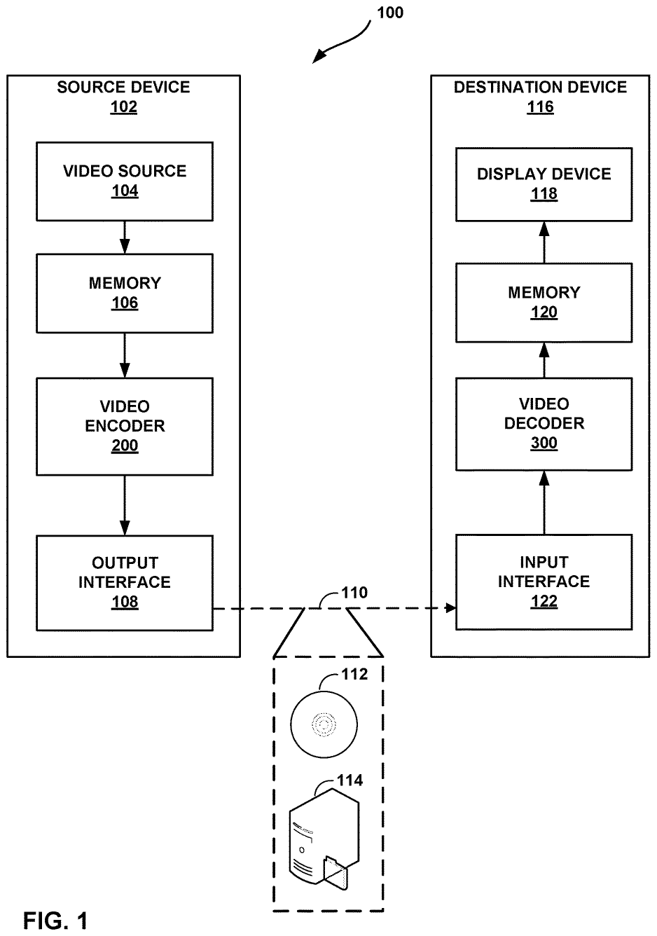

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for encoding and decoding SEI messages. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for encoding and decoding SEI messages. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Audio.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as VVC. In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use constituent rectangles SEI messages and display rectangle SEI messages.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where Mis not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs to exploit cross-component correlations. Different color components may share the same filters (including network structure and model parameters) or each component may have a respective specific filter.

The filtering process can also be generalized as follows:

R′(i,j)=R(i,j)+NN_filter_residual_output(R)

Here, R(i, j) represents a reconstructed sample at position (i, j) in the picture, R′ (i, j) represents the filtered version of the reconstructed sample, and NN_filter_residual_output(R) represents the intermediate samples discussed above that are calculated by the NN filter. The model structure and model parameters of NN-based filter(s) can be pre-defined and be stored at video encoder 200 and video decoder 300. The filters can also be signaled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PRELU layer is an activation function used in neural networks, and is a variant of the ReLU (Rectified Linear Unit) activation function. As described above, the convolution layer outputs feature maps, each corresponding to one filter, representing detected features in the input. Following the convolution layer, the PRELU layer applies the PRELU activation function to each element of the feature maps produced by the convolution layer. For positive values, the PRELU layer acts like a standard ReLU, passing the value through. For negative values, instead of setting them to zero (e.g., as ReLU does), the PRELU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a frame, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g., for 4:2:0 representation, or can be up-sampled to the Luma resolution to achieve per-pixel representation. Similarly, QP, BS, partitioning, or coding mode information can be provided at lower resolution, including cases with a single value per frame, slice or processing block (e.g. QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bit-stream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

Joint Video Experts Team (JVET)-AL2032-v1, Technologies under consideration for future extensions of VSEI (version 8) (hereinafter, VSEI TuC) specifies two rectangle based SEI messages. The constituent rectangles (CR) SEI message enables composition of multiple rectangles within a coded picture in one or more layers and provides information about the rectangles, including ID, type, text description, location, and size. The display rectangles (DR) SEI message describes one or more display rectangles which may be selected to be used to form a recommended display picture from the cropped decoded picture.

The techniques of the disclosure relate to the constituent rectangles supplemental enhancement information messages and the display rectangles supplemental enhancement information messages represent independent concepts. Video encoder 200 and video decoder 300 possess the configuration to utilize the constituent rectangles techniques and the display rectangles techniques separately, or in any combination.

In the following examples, additions are shown between the delimiters <add> and </add>, and deletions are shown between the delimiters <del> and </del>.

Video encoder 200 may be configured to generate and transmit constituent rectangles SEI messages, and video decoder 300 may be configured to receive and process the constituent rectangles SEI messages.

This disclosure describes a constraint on the syntax element cr_num_groups. The syntax element cr_num_groups specifies the maximum number of rectangle groups described in the SEI message. The range of cr_num_groups is proposed as follows.
<add> The value of cr_num_groups shall be in the range of 0 to CrNumRects−1, inclusive</add>

The following constraint modifications are proposed for CR SEI message:
When cr_rect_type_idc[1Idx][i] is in the range of 4 . . . 6, it is a requirement of bitstream conformance that cr_group_enhanced_chroma_format_idc[cr_rect_group_id<add> [1Idx]</add>[i]] is greater than 0.
When cr_group_enhanced_chroma_format_idc[cr_rect_group_id<add> [1Idx] </add> [i]] is greater than 0, for j in the range of 0 . . . cr_num_groups−1, all of the following apply:
There shall be exactly one value y in the range of 0. <del>CrNumRets−1 </del><add>cr_num_rects_in_layer_minus1[1Idx]</add>, inclusive, for which cr_rect_group_id[1Idx][y] equals j and cr_rect_type_idc[1Idx][y] equals 0 or 4.
There shall be exactly one value of u in the range of 0 . . . <del>CrNumRects−1 </del><add>cr_num_rects_in_layer_minus1[1Idx]</add>, inclusive, for which cr_rect_group_id[1Idx][u] equals j and cr_rect_type_idc[1Idx][u] equals 5.
There shall be exactly one value of v in the range of 0 . . . <del>CrNumRets−1</del><add>cr_num_rects_in_layer_minus1[1Idx] </add>, inclusive, for which cr_rect_group_id[1Idx][v] equals j and cr_rect_type_idc[1Idx][v] equals 6.

An additional constraint is proposed as follows to make sure no empty group is specified in CR SEI message
<add> For any j in the range of 0 . . . cr_num_groups−1, there shall be at least one non-empty rectangle in the range of 0 to CrNumRects−1, inclusive, for which the associated cr_rect_group_id, when present, equals to j.</add>

It is proposed to indicate the CR purpose or capability in CR SEI message to indicate the purpose of the composition of multiple rectangles. The CR SEI message may enable the composition of multiple rectangular elements for diverse application scenarios. Instead of signaling an individual flag for each capability, the techniques of the disclosure represent the CR purpose or capability using a bitmask format to ensure future-proof extensibility, which also facilitates prefix indication when multiple CR SEI messages may be indicated within a SEI processing order (SPO) SEI message. The indication may be specified in a bit-wise syntax element as follows.

| | Descriptor |
|---|---|
| constituent_rectangles( payloadSize ) { | |
| <add> cr_purpose</add> | <add> |
| | u(16) |
| | </add> |
| cr_num_layers_minus1 | ue(v) |

<add>cr_purpose indicates the purpose of the CR as specified in Table X, where (cr_purpose & bitMask) not equal to 0 indicates that the CR has the purpose associated with the bitMask value in Table X. When cr_purpose is greater than 0 and (cr_purpose & bitMask) is equal to 0, the purpose associated with the bitMask value is not applicable to the CR. When cr purpose is equal to 0, the CR may be used as determined by the application. </add>

TABLE X
□ Definition of cr_purpose

| □ bitMask | □ Interpretation |
|---|---|
| 0x01 | Multiple views |
| 0x02 | 3D synthesis |
| 0x04 | Transparency effects |
| 0x08 | Object masking |
| 0x10 | Enhanced chroma format |
| 0x20 | Bitdepth range |

The syntax element cr_num_layers_minus1 plus 1 specifies the number of layers for which constituent rectangles are described in the SEI message.

It is proposed to constrain that each purpose associated with the CR SEI message shall apply to at least one rectangle or a rectangle group.

An additional syntax element is proposed to indicate the purpose of each rectangle group as follows.

| | |
|---|---|
| cr_num_groups | ue(v) |
| for( i = 0; i < cr_num_groups; i++ ) | |
| <add> cr_group_purpose[ i ] </add> | <add> |
| | u(16) |
| | </add> |

<add>cr_group_purpose[i] indicates the purpose of i-th rectangle group as specified in Table X. The i-th group purpose shall match at most one of the purposes indicated in cr_purpose. </add>

This disclosure proposes a condition on the syntax element cr_rect_id_len_minus1. The syntax element, cr_rect_id_len_minus1, is present when cr_rect_id_present_flag is equal to 1 or cr_associated_rect_id_enabled_flag is equal to 1 as specified in current TuC. As the syntax element cr_rect_id_present_flag is not present before the syntax element cr_rect_id_len_minus1, it is proposed to condition the syntax element, cr_rect_id_len_minus1, by cr_rect_id_enabled_flag and cr_associated_rect_id_enabled_flag as follows.

| | Descriptor |
|---|---|
| constituent_rectangles( payloadSize ) { | |
| cr_enhanced_chroma_format_enabled_flag | u(1) |
| cr_num_layers_minus1 | ue(v) |
| for( lIdx = 0; lIdx <= cr_num_layers_minus1; lIdx ++ ) { | |
| cr_layer_id[ lIdx ] | ue(v) |
| if( lIdx>0 ) { | |
| cr_reuse_layout_flag[ lIdx ] | |
| if( cr_reuse_layout_flag[ lIdx ] ) | |
| cr_reuse_layer_idx[ lIdx ] | ue(v) |
| } | |
| if( lIdx == 0 \|\| !cr_reuse_layout_flag[ lIdx ] ) | |
| cr_num_rects_in_layer_minus1[ lIdx ] | u(8) |
| } | |
| } | |
| cr_rect_id_enabled_flag | u(1) |
| cr_associated_rect_id_enabled_flag | u(1) |
| cr_num_groups | ue(v) |
| if( <del>cr_rect id present_flag</del> <add>cr_rect_id_enable | |
| d_flag</add> \|\| cr_associated_rect_id_enabled_flag ) | |
| cr_rect_id_len_minus1 | u(4) |
| cr_subpic_idx_enabled_flag | u(1) |

This disclosure describes techniques related to derivation of the length of the cr_rect_id[i] and cr_associated_rect_id[i] syntax elements.
cr_rect_id_len_minus1 plus 1 specifies the length of the cr_rect_id[i] and cr_associated_rect_id[i] syntax elements. It is asserted that the length can be derived from the max number of constituent rectangles in a layer from the syntax element cr_num_rects_in_layer_minus1[1Idx].

It is proposed to remove syntax element, <add>cr_rect_id_len_minus1</add>, and derive the length as follows.
<add>
RectIdLen=0
for(1Idx=0; 1Idx<=cr_num_layers_minus1; 1Idx++)
   RectIdLen=Max(RectIdLen,
      Ceil(Log 2 (cr_num_rects_in_layer_minus1[1Idx])))
</add>

This disclosure describes a condition on the syntax element cr_rect_id_present_flag. It is proposed to condition the presence of the syntax element cr_rect_id_present_flag by the CR rectangle type, cr_rect_type_idc because the empty CR does not need an identifier. For an empty constituent rectangle, signaling an identifier may be disabled. However, an empty constituent rectangle has an identifier, which is inferred. Because existing techniques constrain all supplemental enhancement information messages from referencing an empty constituent rectangle, there is no need to explicitly signal its identifier. As the constituent rectangle ID is not defined for an empty rectangle, all constraints preventing referencing such rectangles may be removed.

| | |
|---|---|
| if( cr_rect_id_enabled_flag <add>&& cr_rect_type_idc[ | |
| lIdx ][ i ] != 255</add>) { | |
| cr_rect_id_present_flag[ lIdx ][ i ] | u(1) |
| if( cr_rect_id_present_flag ) | |
| cr_rect_id[ lIdx ][ i ] | u(v) |
| } | |

This disclosure describes a condition on the syntax element cr_associated_rect_id_present_flag. Current TuC CR SEI message signals cr_associated_rect_id_present_flag when cr_associated_rect_id_enabled_flag equals 1 and rectangle type is not CR TEXTURE. It is asserted that the rectangle type equal to CR_Y shall not associate with other rectangles, additional condition for cr_associated_rect_id_present_flag is proposed as follows.

| | |
|---|---|
| if( cr_associated_rect_id_enabled_flag && cr_rect_type_idc[ lIdx | |
| ][ i ] != 0 <add>&& cr_rect_type_idc[ lIdx ][ i ] != 4) </add> { | |
| cr_associated_rect_id_present_flag[ Idx ][ i ] | u(1) |
| if( cr_associated_rect_id_present_flag[ lIdx ][ i ] ) | |
| cr_associated_rect_id[ lIdx ][ i ] | u(v) |

}

This disclosure describes a modification on the syntax element cr_rect_group_id.
cr_rect_group_id[1Idx][i] indicates the group ID of the i-th rectangle of the 1Idx-th layer. Since the group ID is not specified in the CR SEI message and the value of cr_rect_group_id[1Idx][i] is in the range of 0 to cr_num_groups−1, inclusive, it is proposed to modify the syntax element to <add>cr_rect_group_idx[1Idx][i] </add><del>cr_rect_group_id[1Idx][i]</del> with the following semantic.
<add>cr_rect_group_idx[1Idx][i] indicates the group index of the i-th rectangle of the 1Idx-th layer. The length of the syntax element is Ceil(Log 2(cr_num_groups)) bits. The value of cr_rect_group_idx[1Idx][i] shall be in the range of 0 to cr_num_groups−1, inclusive. When not present and cr_rect_type_idc[1Idx][i] is not equal to 255, the value of cr_rect_group_idx[1Idx][i] is inferred to be equal to 0. When not present and cr_reuse_layout_flag[1Idx] is equal to 1, cr_rect_group_idx[1Idx][i] is inferred to be equal to cr_rect_group_idx[cr_reuse_layer_idx[1Idx]][i]. </add>
<del>cr_rect_group_id[1Idx][i] indicates the group ID of the i-th rectangle of the 1Idx-th layer. The length of the syntax element is Ceil(Log 2(cr_num_groups) bits. The value of cr_rect_group_id[1Idx][i] shall be in the range of 0 to cr_num_groups−1, inclusive. When not present and cr_rect_type_idc[1Idx][i] is not equal to 255, the value of cr_rect_group_id[1Idx][i] is inferred to be equal to 0. When not present and cr_reuse_layout_flag[1Idx] is equal to 1, cr_rect_group_id[1Idx][i] is inferred to be equal to cr_rect_group_id[cr_reuse_layer_idx[1Idx]][i]. </del>

This disclosure describes a constraint on rectangle type.
TuC specifies rectangle type syntax element, cr_rect_type_idc[1Idx][i], to indicate the constituent picture type of the i-th rectangle from Table 1 for the 1Idx-th layer.

TABLE 1
Mapping of cr_rect_type_idc[ lIdx ][ i ]
to the type of constituent rectangle

| | | Type of |
|---|---|---|
| | | constituent |
| cr_rect_type_idc[ lIdx ][ i ] | Name | rectangle |
| 0 | CR_TEXTURE | Texture |
| 1 | CR_ALPHA | Alpha plane |
| 2 | CR_DEPTH | Depth picture |
| 3 | CR_OBJECT_MASK | Object mask |
| 4 | CR_Y | Y component |
| 5 | CR_CB | Cb component |
| 6 | CR_CR | Cr component |
| 4 . . . 127 | | Reserved |
| 128 . . . 254 | | Unspecified |
| 255 | CR_EMPTY | Empty |

A constraint is proposed to avoid the rectangles indicated by CR SEI message are all empty as follows.
<add>There shall be at least one rectangle indicated by a CR SEI message with the rectangle type not equal to 255. </add>

Another example constraint is proposed as follows:
<add>There shall be at least one value of cr_rect_type_idc[1Idx][i] not equal to 255 for 1Idx in the range of 0 to cr_num_layers_minus1, inclusive and i in the range of 0 to cr_num_rects_in_layer_minus1[1Idx], inclusive. </add>

This disclosure describes a constraint on rectangle identifier and associated identifier. TuC specifies that cr_associated_rect_id[1Idx][i] indicates the ID of an associated primary rectangle of the i-th rectangle of the 1Idx-th layer. A primary rectangle is a constituent rectangle with cr_rect_type_idc equal to 0. Since the CR_U and CR_V rectangle types shall associate with the CR_Y rectangle, it is proposed to add cr_rect_type_idc equal to 4, CR_Y, as a primary rectangle as follows.
A primary rectangle is a constituent rectangle with cr_rect_type_idc equal to 0 <add> or cr_rect_type_idc equal to 4</add>.
TuC specifies that it is a requirement of bitstream conformance that when present, the value of cr_associated_rect_id[i] shall be equal to cr_rect_id[1Idx][j] for some value of j in the range of 0 to CrNumRects−1, inclusive, and cr_rect_type_idc[1Idx][j] shall not be equal to 255.

It is proposed to modify the above constraint as follows.

It is a requirement of bitstream conformance that when present, the value of <add>cr_associated_rect_id[1Idx][i]</add><del>cr_associated_rect_id[i]</del>shall be equal to cr_rect_id[1Idx][j] for some value of j in the range of 0 to <del>CrNumRects−1</del><add>cr_num_rects_in_layer_minus1[1Idx]</add>, inclusive, and <add>cr_rect_type_idc[1Idx][i]</add><del>cr_rect_type_idc[1Idx][j]</del> shall not be equal to 255<add> and cr_rect_id[1Idx][j] shall be equal to 0 or 4</add>.

Another example constraint is proposed as below in case the current rectangle and the associated rectangle are located in different layers.

It is a requirement of bitstream conformance that when present, the value of cr_associated_rect_id[1Idx][i] shall be equal to cr_rect_id[1][j] for some value of j in the range of 0 to cr_num_rects_in_layer_minus1[1Idx], inclusive, and for some value of 1 in the range of 0 to cr_num_layers_minus1, inclusive, and cr_rect_type_idc[1Idx][i] shall not be equal to 255 and cr_rect_id[1][j] shall be equal to 0 or 4.

It is asserted that a primary picture may be in a different layer than the current 1Idx-th layer, and the rectangle identifier of different layers may be the same when a CR layout related parameters of one layer is reused in another layer. Known techniques assume the associated rectangle layer is always the same layer as the current layer, but the layers may be different. A flag can signal whether the associated rectangle layer index is presented or not. If not present, the associated rectangle layer index defaults to the same layer as the current layer. It is proposed to signal the layer of the associated primary rectangle as follows.

| | |
|---|---|
| if( cr_associated_rect_id_enabled_flag && cr_rect_type_idc[ lIdx ][ i ] != | |
| 0 ) { | |
| cr_associated_rect_id_present_flag[ lIdx ][ i ] | u(1) |
| if( cr_associated_rect_id_present_flag[ lIdx ][ i ] ) <add>{</add> | |
| <add>cr_associated_rect_layer_idx_present_flag[ lIdx ][ i ] | <add> |
| </add> | u(1) |
| | </add> |
| <add>if( cr_associated_rect_layer_idx_present_flag[ lIdx ][ i ] ) | |
| </add> | |
| <add>cr_associated_rect_layer_idx[ lIdx ][ i ] </add> | <add> |
| | ue(v) |
| | </add> |
| cr_associated_rect_id[ lIdx ][ i ] | u(v) |
| <add> }</add> | |
| } | |

<add>cr_associated_rect_layer_idx_present_flag[1Idx][i] equal to 1 specifies that the cr_associated_rect_layer_idx[1Idx][i] syntax element is present in the SEI message. cr_associated_rect_layer_idx_present_flag[1Idx][i] equal to 0 specifies that the cr_associated_rect_layer_idx[1Idx][i] syntax element is not present in the SEI message. </add>
<add>cr_associated_rect_layer_idx[1Idx][i] when present, indicates the layer index of an associated rectangle of the i-th rectangle of the 1Idx-th layer. cr_associated_rect_layer_idx[1Idx][i] shall be less than or equal to 1Idx. When not present, the value of cr_associated_rect_layer_idx[1Idx][i] is inferred to be equal to 1Idx. </add>
cr_associated_rect_id[1Idx][i] indicates the ID of an associated primary rectangle of the i-th rectangle of the 1Idx-th layer. The length of the syntax element is cr_rect_id_len_minus1+1 bits. When not present and cr_reuse_layout_flag[1Idx] is equal to 1, cr_associated_rect_id[1Idx][i] is inferred to be equal to cr_associated_rect_id[cr_reuse_layer_idx[1Idx]][i].

A primary rectangle is a constituent rectangle with cr_rect_type_idc equal to 0 or cr_rect_type_idc equal to 4.
It is a requirement of bitstream conformance that when present, the value of cr_associated_rect_id<add>[1Idx]</add> [i] shall be equal to cr_rect_id[<del>1Idx</del><add>cr_associated_rect_layer_idx[1Idx][i]</add>][j] for some value of j in the range of 0 to CrNumRects−1, inclusive, and cr_rect_type_idc[Idx][j] shall not be equal to 255.
When not present, the value of cr_associated_rect_id<add> [1Idx]</add>[i] is undefined.

In some examples, the layer identifier of the associated rectangle may be indicated as follows.

| | |
|---|---|
| if( cr_associated_rect_id_enabled_flag && cr_rect_type_idc[ lIdx ][ i ] != | |
| 0 ) { | |
| cr_associated_rect_id_present_flag[ lIdx ][ i ] | u(1) |
| if( cr_associated_rect_id_present_flag[ lIdx ][ i ] ) <add>{</add> | |
| <add>cr_associated_rect_layer_id_present_flag[ lIdx ][ i ] </add> | <add> |
| | u(1) |
| | </add> |
| <add>if( cr_associated_rect_id_present_flag[ lIdx ][ i ] ) </add> | |
| <add>cr_associated_rect_layer_id[ lIdx ][ i ] </add> | <add> |
| | ue(v) |
| | </add> |
| cr_associated_rect_id[ lIdx ][ i ] | u(v) |
| <add>}</add> | |
| } | |

<add>cr_associated_rect_layer_id_present_flag[1Idx][i] equal to 1 specifies that the cr_associated_rect_layer_id[1Idx][i] syntax element is present in the SEI message. cr_associated_rect_layer_id_present_flag[1Idx][i] equal to 0 specifies that the cr_associated_rect_layer_id[1Idx][i] syntax element is not present in the SEI message. </add>
<add>cr_associated_rect_layer_id[Idx][i] when present, indicates the layer identifier of an associated rectangle of the i-th rectangle of the 1Idx-th layer. When not present and cr_reuse_layout_flag[1Idx] is equal to 0 the value of cr_associated_rect_layer_id[1Idx][i] is inferred to be equal to cr_layer_id[1Idx]. When not present and cr_reuse_layout_flag[1Idx] is equal to 1, cr_associated_rect_layer_id[1Idx] [i] is inferred to be equal to cr_associated_rect_layer_id[cr_reuse_layer_idx[1Idx]] [i]. cr_associated_rect_layer_id[1Idx][i] shall be equal to one of the cr_layer_id[1Idx] where 1Idx is in the range of 0 to cr_num_layers_minus1, inclusive. </add>

In some examples, the identifier of each rectangle may be constrained to be different so that the associated rectangle id is sufficient to indicate different rectangle. The proposed constraint is as follows:
It is a requirement of bitstream conformance that when j not equal to k<add> or 1IdxA not equal to 1IdxB</add>,
cr_rect_id[<del>1Idx</del><add>1IdxA</add>][j] shall not be equal to cr_rect_id[</del>1Idx</del><add>1IdxB</add>][k].

To avoid signalling the associated layer, a constraint shall be specified that the associated rectangle of the i-th rectangle of the Idx-th layer shall be on the same 1Idx-th layer.

This disclosure describes techniques to enable bitdepth range in CR SEI message. Bitdepth range information SEI message allocates bit ranges of the original source picture to one or more ranges coded in separate layer pictures, subpictures, or constituent rectangles. It is proposed to support bitdepth ranges in the CR SEI message. Additional syntax elements and semantics proposed to CR SEI message to enable Bitdepth range are as follows.

| <add>cr_bitdepth_range_enabled_flag</add> | | u(1) |
|---|---|---|
| if(cr_bitdepth_range_enabled_flag) | | |
| <add>cr_orig_bit_depth_minus1</add> | | u(4) |
| ... | | |
| if( cr_enhanced_chroma_format_enabled_flag ) { | | |
| | for( i = 0; i < cr_num_groups; i++ ) { | |
| <add>cr_group_bitdepth_range_flag[ i ] </add> | | u(1) |
| ... | } | |
| } | | |
| ... | | |
| for ( lIdx = 0, i = 0; lIdx <= cr_num_layers_minus1; lIdx++ ) { | | |
| | if( lIdx == 0 \|\| !cr_reuse_layout_flag[ lIdx ] ) { | |
| | for( crIdx = 0; crIdx <= cr_num_rects_in_layer_minus1[ lIdx ]; | |

| crIdx++ ) | | |
|---|---|---|
| | if( cr_rect_type_idc[ lIdx ][ crIdx ] != 255 ) { | |
| | if( cr_num_groups > 0 ) | |
| | cr_rect_group_idx[ lIdx ][ crIdx ] | u(8) |
| | if(cr_group_bitdepth_range_flag[cr_rect_group_idx[ lIdx ][ | |
| crIdx ]]) { | | |
| <add> | cr_num_bits_in_range_minus1[ lIdx ][crIdx ] </add> | u(4) |
| <add> | cr_bit_offset[ lIdx ][ crIdx ] </add> | u(4) |
| | } | |
| | } | |

}
}

}

cr_bitdepth_range_enabled_flag equal to 1 indicates that the cr_orig_bit_depth_minus1 syntax element is present. cr_bitdepth_range_enabled_flag equal to 0 indicates that the cr_orig_bit_depth_minus1 syntax element is not present.

In another example, cr_bitdepth_range_enabled_flag value may be inferred from (cr_purpose & 0x20).
<add>
cr_orig_bit_depth_minus1 plus 1 specifies the bit depth of the original picture
cr_group_bitdepth_range_flag[i] equal to 1 indicates the i-th group contains bitdepth range rectangles. cr_group_bitdepth_range_flag[i] equal to 0 indicates the i-th group does not contain bitdepth range rectangles.
cr_num_bits_in_range_minus1[1Idx][crIdx] plus 1 specifies the number of bits of the crIdx-th rectangle of the 1Idx-th layer.
cr_bit_offset [1Idx][crIdx] specifies a bit shifting parameter used to derive the target picture.
</add>

Video encoder 200 may be configured to generate and transmit a semantic of cr_enhanced_chroma_format_enabled_flag.

It is proposed to modify the semantic of syntax element, cr_enhanced_chroma_format_enabled_flag, as highlighted below because the syntax element cr_group_enhanced_chroma_format_idc[i] may or may not be present when cr_enhanced_chroma_format_enabled_flag equal to 1.
cr_enhanced_chroma_format_enabled_flag equal to 1 indicates that the cr_group_enhanced_chroma_format_idc[i] syntax element <del> is </del><add> may be </add>present. cr_enhanced_chroma_format_enabled_flag equal to 0 indicates that the cr_group_enhanced_chroma_format_idc[i] syntax element is not present.

Video encoder 200 may be configured to generate and transmit display rectangles SEI messages, and video decoder 300 may be configured to receive and process the display rectangles SEI messages.

This disclosure describes constraints on DR update. TuC specifies that when dr_pos_updates_flag is equal to 1, it is a requirement of bitstream conformance that the value of dr_num_rect_minus1 shall be less than or equal to the value of the corresponding syntax element in the previous DR SEI message. As the display rectangles property is specified when dr_pos_updates_flag equals to 0, the position update shall be based on the display rectangles property, e.g., the initial display rectangles property, instead of previous updated DR SEI message. The constraint is modified as follows to make sure that one or more of the original specified display rectangles are updated.

When dr_pos_updates_flag is equal to 1, it is a requirement of bitstream conformance that the value of dr_num_rect_minus1 shall be less than or equal to the value of the corresponding syntax element in the <del>previous</del>DR SEI message <add> with dr_pos_updates_flag equal to 0 and dr_cancel_flag equal to 0 preceding current DR SEI message in output order</add>.

In some examples, a constraint modification is as follows.

When dr_pos_updates_flag is equal to 1, it is a requirement of bitstream conformance that the value of dr_num_rect_minus1 shall be less than or equal to the value of the corresponding syntax element in the previous-DR SEI message <add> that was present in the same layer with the current DR SEI message in output order which explicitly signaled the display rectangle information</add>.

Additional constraints are proposed as follows to ensure a DR SEI message with the value of dr_pos_updates_flag equal to 0 shall precede all subsequent DR SEI messages containing an update of one or multiple display rectangles.
<add>When there is a DR SEI message, drA, with dr_pos_updates_flag equal to 1, there shall be a DR SEI message, drB, with dr_pos_updates_flag equal to 0 and dr_cancel_flag equal to 0 in the layer that contains drA SEI message precedes drA in output order, and there is no DR SEI message with dr_cancel flag equal to 1 between drA and drB. </add>

Another example constraint is proposed as follows.
<add>When the current DR SEI message is the first DR SEI message, in output order, in the current Coded Layer Video Sequence (CLVS), the value of the dr_pos_updates_flag shall be equal to 0. </add>

This disclosure describes constraints on display rectangle identifier.
dr_assigned_rect_id[i] specifies the identifier for the i-th display rectangle, a constraint is proposed to ensure the uniqueness of the rectangle identifier as follows.
<add>It is a requirement of bitstream conformance that when j not equal to k, dr_assigned_rect_id[j] shall not be equal to dr_assigned_rect_id[k]. </add>
dr_rect_id[i] specifies the identifier for the i-th display rectangle, a constraint is proposed to ensure the uniqueness of the rectangle identifier as follows.
<add>It is a requirement of bitstream conformance that when j not equal to k,
dr_rect_id[j] shall not be equal to dr_rect_id[k].</add>

The updated rectangle with dr_rect_id[i] shall match one of the initial rectangle with dr_assigned_rect_id[j]. A constraint is proposed as follows.
<add>It is a requirement of bitstream conformance that dr_rect_id[i] for i in the range of 0 to 15 shall be equal to dr_assigned_rect_id[j] of one rectangle indicated in the previous DR SEI message with dr_pos_updates_flag equal to 0 present in the CLVS. </add>

This disclosure describes a condition on the signaling of a display rectangle identifier. Generally the display rectangle identifier may be inferred from its index, a gating flag is proposed to condition the signaling of the syntax element, dr_assigned_rect_id[i], as follows.

| | |
|---|---|
| <add>dr_assigned_rect_id_present_flag</add> | <add> |
| | u(1) |
| | </add> |
| if ( !dr_pos_updates_flag ) { | |
| <add> if(dr_assigned_rect_id_present_flag) </add> | |
| for( i = 0; i <= dr_num rect_minus1; i++ ) | |
| dr_assigned_rect_id[ i ] | ue(v) |

<add>dr_assigned_rect_id_present_flag equal to 1 specifies that dr_assigned_rect_id[i] is present in the SEI message. dr_assigned_rect_id_present_flag equal to 0 specifies dr_assigned_rect_id[i] is not present in the SEI message. </add>
dr_assigned_rect_id[i] specifies the identifier for the i-th display rectangle. <add>When not present, the value of dr_assigned_rect_id[i] is inferred to be equal to i. </add> The value of dr_assigned_rect_id[i] shall be in the range of 0 to 15, inclusive.

The syntax element, dr_assigned_rect_id_present_flag, may be signaled only when dr_pos_updates_flag equal to 0, and an additional 1 bit may be signaled when dr_assigned_rect_id_present_flag is equal to 1 for the byte alignment.

This disclosure proposes semantic modification. The DR SEI message semantic modifications are as follows.
dr_rect_width [i] specifies the width of the i-th rectangle in units <add> of DrUnitSizeInit luma samples</add>. When not present, the value of dr_rect_width[i] is inferred to be equal to the value of the corresponding syntax element in the previous DR SEI message in output order.
dr_rect_height [i], when present, specifies the height of the i-th rectangle <del> in terms of DrUnitSizeInit unit size</del><add> in units of DrUnitSizeInit luma samples</add>. When not present and dr_display_aspect_ratio[i] is equal to 0, the value of dr_rect_height[i] is inferred to be equal to the value of the corresponding syntax element in the previous DR SEI message in output order.
dr_fill_content_width[i] specifies the width of the content region used for filling of the i-th display rectangle, in DrUnitSizeInit units <add> of luma samples</add>. When not present, the value of dr_fill_content_width[i] is set to the value of corresponding syntax element in the previous DR SEI message in output order.

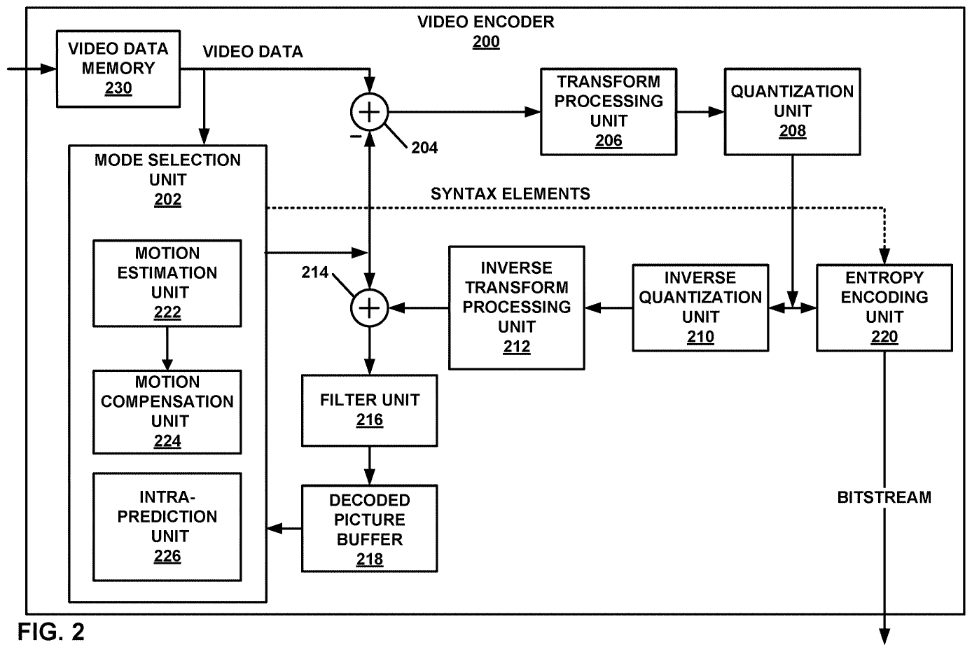

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

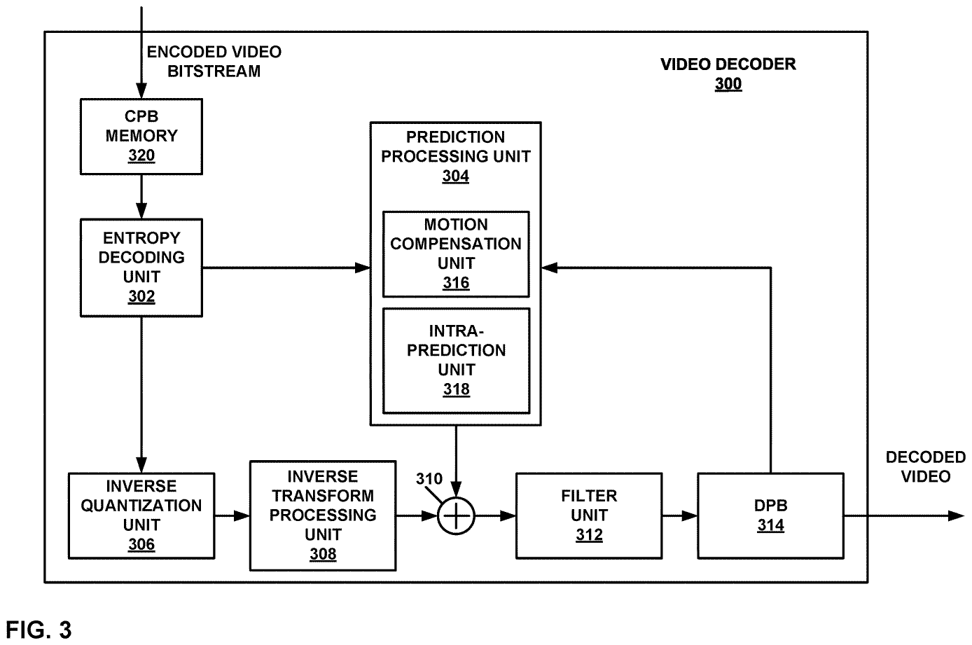

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

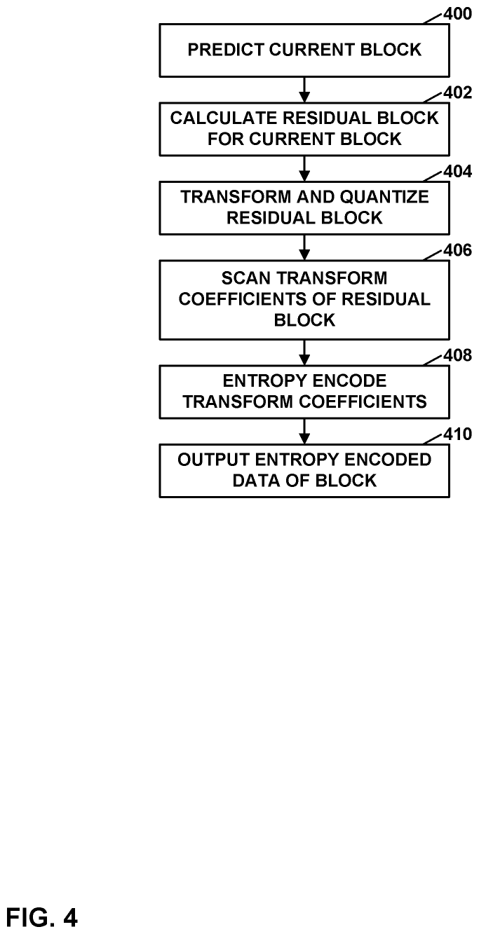

FIG. 4 is a flowchart illustrating an example method for encoding a current block in accordance with the techniques of this disclosure. The current block may be or include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

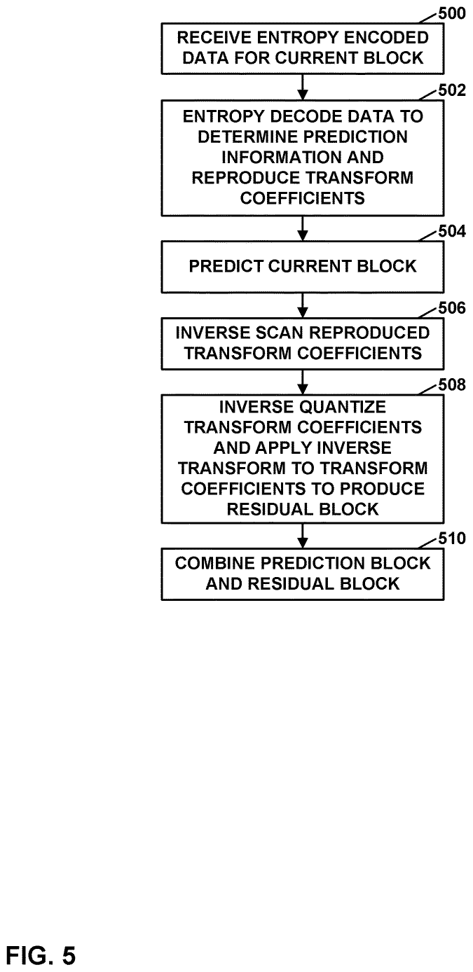

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

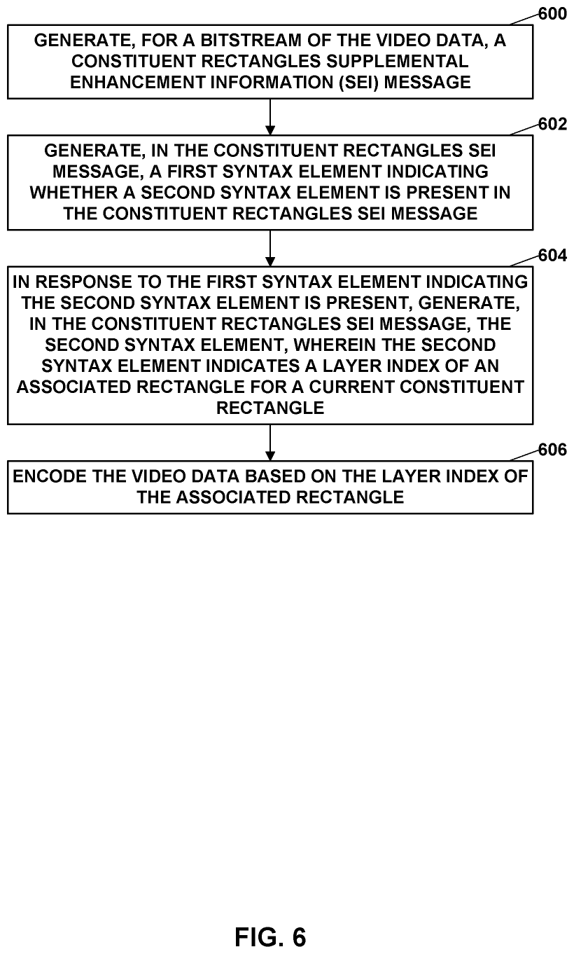

FIG. 6 is a flowchart illustrating an example process for encoding video data in accordance with the techniques of this disclosure. Video encoder 200 generates, for a bitstream of the video data, a constituent rectangles SEI message (600). The constituent rectangles SEI message enables composition of multiple rectangles within a coded picture in one or more layers. A current constituent rectangle includes a rectangular region within the coded picture of the video data.

Video encoder 200 generates, in the constituent rectangles SEI message, a first syntax element (e.g., cr_associated_rect_layer_idx_present_flag[1Idx][i] described above) indicating whether a second syntax element (e.g., cr_associated_rect_layer_idx[1Idx][i] described above) is present in the constituent rectangles SEI message (602). In response to the first syntax element indicating the second syntax element is present, video encoder 200 generates, in the constituent rectangles SEI message, the second syntax element, wherein the second syntax element indicates a layer index of an associated rectangle for the current constituent rectangle (604). The layer index of the associated rectangle is less than or equal to a current layer index for the current constituent rectangle. In response to the first syntax element indicating the second syntax element is absent from the constituent rectangles SEI message, video encoder 200 determines the layer index of the associated rectangle equals the current layer index for the current constituent rectangle.

Video encoder 200 generates, in the constituent rectangles SEI message, a third syntax element (e.g., cr_associated_rect_id[1Idx][i] described above) indicating an identifier of an associated primary rectangle for the current constituent rectangle. Video encoder 200 generates a fourth syntax element (e.g., cr_rect_id_len_minus1 described above) indicating a length parameter for rectangle identifiers. Video encoder 200 determines a length of the third syntax element based on the fourth syntax element. In some examples, video encoder 200 omits the third syntax element from the constituent rectangles SEI message and generates a reuse layout flag indicating a reuse of a layout for the current constituent rectangle from a reference layer. Based on the reuse layout flag, video encoder 200 determines the identifier of the associated primary rectangle equals a reference identifier of a reference associated primary rectangle in the reference layer.

To process subsequent messages, video encoder 200 generates, for the bitstream of the video data, a second constituent rectangles SEI message. Video encoder 200 generates, in the second constituent rectangles SEI message, a second instance of the first syntax element indicating whether a second instance of the second syntax element is present in the second constituent rectangles SEI message. Video encoder 200 generates the second instance of the first syntax element to indicate the second instance of the second syntax element is absent from the second constituent rectangles SEI message. Video encoder 200 determines a second layer index of a second associated rectangle for a second constituent rectangle equals a current layer index for the second constituent rectangle based on the second instance of the second syntax element being absent.

Video encoder 200 encodes the video data based on the layer index of the associated rectangle (606). To encode the video data based on the layer index of the associated rectangle, video encoder 200 identifies a layer corresponding to the layer index. Video encoder 200 identifies the associated primary rectangle within the layer. Video encoder 200 composes the current constituent rectangle and the associated primary rectangle to output a reconstructed picture.

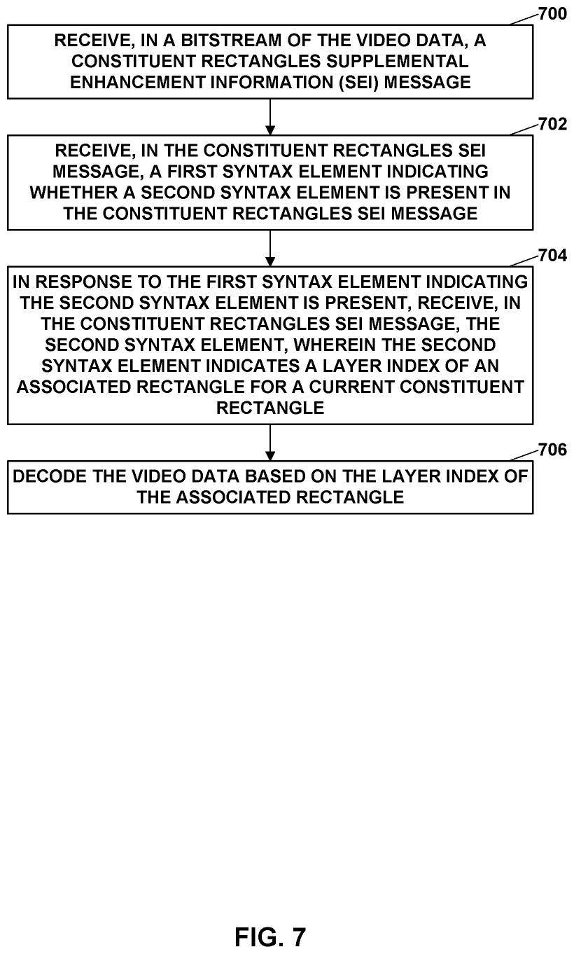

FIG. 7 is a flowchart illustrating an example process for decoding video data in accordance with techniques of the disclosure. Video decoder 300 receives, in a bitstream of the video data, a constituent rectangles supplemental enhancement information (SEI) message (700). The constituent rectangles SEI message enables composition of multiple rectangles within a coded picture in one or more layers. A current constituent rectangle includes a rectangular region within the coded picture of the video data.

Video decoder 300 receives, in the constituent rectangles SEI message, a first syntax element indicating whether a second syntax element is present in the constituent rectangles SEI message (702). The first syntax element comprises a cr_associated_rect_layer_idx_present_flag syntax element. In response to the first syntax element indicating the second syntax element is present, video decoder 300 receives, in the constituent rectangles SEI message, the second syntax element, wherein the second syntax element indicates a layer index of an associated rectangle for the current constituent rectangle (704). The second syntax element comprises a cr_associated_rect_layer_idx syntax element. The layer index of the associated rectangle is less than or equal to a current layer index for the current constituent rectangle.

Video decoder 300 determines the first syntax element indicates the second syntax element is absent from the constituent rectangles SEI message. Video decoder 300 infers the layer index of the associated rectangle equals the current layer index for the current constituent rectangle based on the second syntax element being absent.

Video decoder 300 receives, in the constituent rectangles SEI message, a third syntax element indicating an identifier of an associated primary rectangle for the current constituent rectangle. The third syntax element comprises a cr_associated_rect_id syntax element. The associated primary rectangle comprises a constituent rectangle having a cr_rect_type_idc syntax element equal to 0 or a cr_rect_type_idc syntax element equal to 4. Video decoder 300 determines a length of the third syntax element based on a fourth syntax element, the fourth syntax element indicating a length parameter for rectangle identifiers.

Video decoder 300 determines the third syntax element is absent from the constituent rectangles SEI message. Video decoder 300 determines a reuse layout flag indicates a layout for the current constituent rectangle is reused from a reference layer. Video decoder 300 infers the identifier of the associated primary rectangle equals a reference identifier of a reference associated primary rectangle in the reference layer based on the reuse layout flag.

Video decoder 300 receives, in the bitstream of the video data, a second constituent rectangles SEI message. Video decoder 300 receives, in the second constituent rectangles SEI message, a second instance of the first syntax element indicating whether a second instance of the second syntax element is present in the second constituent rectangles SEI message. Video decoder 300 determines the second instance of the first syntax element indicates the second instance of the second syntax element is absent from the second constituent rectangles SEI message. Video decoder 300 infers a second layer index of a second associated rectangle for a second constituent rectangle equals a current layer index for the second constituent rectangle based on the second instance of the second syntax element being absent.

Video decoder 300 decodes the video data based on the layer index of the associated rectangle (706). To decode the video data based on the layer index of the associated rectangle, video decoder 300 identifies a layer corresponding to the layer index. Video decoder 300 identifies the associated primary rectangle within the layer. Video decoder 300 composes the current constituent rectangle and the associated primary rectangle to output a decoded picture. To compose the current constituent rectangle and the associated primary rectangle, video decoder 300 may, for example, determine a first set of spatial coordinates for the current constituent rectangle and a second set of spatial coordinates for the associated primary rectangle. Video decoder 300 maps the first set of spatial coordinates and the second set of spatial coordinates to a target spatial resolution for the decoded picture. Based on the mapping, video decoder 300 merges sample values of the current constituent rectangle and sample values of the associated primary rectangle within a decoded picture buffer. When the layer index of the associated primary rectangle identifies a layer having a different resolution than a current layer of the current constituent rectangle, video decoder 300 applies a scaling operation to align the sample values prior to merging the sample values. Video decoder 300 outputs the contents of the decoded picture buffer to present the decoded picture.

The following numbered clauses illustrate one or more aspects of the devices and techniques described in this disclosure.

Clause 1: A method of decoding encoded video data, the method comprising: receiving a constituent rectangles supplemental enhancement information (SEI) message in the encoded video data; and receiving, in the constituent rectangles SEI message, a syntax element indicating a purpose for constituent rectangles in the video data.

Clause 2: A method of decoding encoded video data, the method comprising: receiving a constituent rectangles supplemental enhancement information (SEI) message in the encoded video data; and receiving the constituent rectangles SEI message, a syntax element indicating a type for constituent rectangles in the video data.

Clause 3: A method of decoding encoded video data, the method comprising: receiving a constituent rectangles supplemental enhancement information (SEI) message in the encoded video data; and receiving, in the constituent rectangles SEI message, a syntax element indicating a bit depth range for constituent rectangles in the video data.

Clause 4: A method of decoding encoded video data, the method comprising: receiving a display rectangle supplemental enhancement information (SEI) message in the encoded video data; receiving a flag in the display rectangle SEI message; and based on a value of the flag, receiving an additional syntax element indicating one or more identifiers for one or more display rectangles.

Clause 5: A method of decoding encoded video data, the method comprising:
receiving a constituent rectangles supplemental enhancement information (SEI) message in the encoded video data; and receiving, in the constituent rectangles SEI message, a flag, wherein a first value for the flag indicates that an instance of a cr_group_enhanced_chroma_format_idc[i] syntax element is permitted to be present and a second value of the flag indicates the instance of the cr_group_enhanced_chroma_format_idc[i] syntax element is not present.

Clause 6: A method of decoding encoded video data, the method comprising: receiving a constituent rectangles supplemental enhancement information (SEI) message in the encoded video data; and receiving, in the constituent rectangles SEI message, a syntax element indicating an identification number of an associated primary rectangle.

Clause 7: A device for coding video data, the device comprising one or more means for performing the method of any of clauses 1-6.

Clause 8: The device of clause 7, wherein the one or more means comprise one or more processors implemented in circuitry.

Clause 9: The device of any of clauses 7 and 8, further comprising a memory to store the video data.

Clause 10: The device of any of clauses 7-9, further comprising a display configured to display decoded video data.

Clause 11: The device of any of clauses 7-10, wherein the device comprises one or more of a camera, a computer, a mobile device, a broadcast receiver device, or a set-top box.

Clause 12: The device of any of clauses 7-11, wherein the device comprises a video decoder.

Clause 13: The device of any of clauses 7-12, wherein the device comprises a video encoder.

Clause 14: A computer-readable storage medium having stored thereon instructions that, when executed, cause one or more processors to perform the method of any of clauses 1-6.

Examples of the various aspects of this disclosure may be used individually or in any combination. Additional aspects of the disclosure are detailed in numbered clauses below.

Clause 15. A method for decoding video data, the method comprising receiving, in a bitstream of the video data, a constituent rectangles supplemental enhancement information (SEI) message, receiving, in the constituent rectangles SEI message, a first syntax element indicating whether a second syntax element is present in the constituent rectangles SEI message, in response to the first syntax element indicating the second syntax element is present, receiving, in the constituent rectangles SEI message, the second syntax element, wherein the second syntax element indicates a layer index of an associated rectangle for a current constituent rectangle, and decoding the video data based on the layer index of the associated rectangle.

Clause 16. The method of Clause 15, further comprising receiving, in the constituent rectangles SEI message, a third syntax element indicating an identifier of an associated primary rectangle for the current constituent rectangle.

Clause 17. The method of Clause 15, further comprising determining the third syntax element is absent from the constituent rectangles SEI message, determining a reuse layout flag indicates a layout for the current constituent rectangle is reused from a reference layer, and inferring the identifier of the associated primary rectangle equals a reference identifier of a reference associated primary rectangle in the reference layer based on the reuse layout flag.

Clause 18. The method of Clause 16, further comprising determining a length of the third syntax element based on a fourth syntax element, the fourth syntax element indicating a length parameter for rectangle identifiers.

Clause 19. The method of any of Clauses 15-18, wherein decoding the video data based on the layer index of the associated rectangle comprises identifying a layer corresponding to the layer index, identifying an associated primary rectangle within the layer, and composing the current constituent rectangle and the associated primary rectangle to output a decoded picture.

Clause 20. The method of any of Clauses 15-19, wherein the current constituent rectangle comprises a rectangular region within a coded picture of the video data.

Clause 21. The method of any of Clauses 15-20, further comprising determining the first syntax element indicates the second syntax element is absent from the constituent rectangles SEI message, and inferring the layer index of the associated rectangle equals a current layer index for the current constituent rectangle based on the second syntax element being absent.

Clause 22. The method of any of Clauses 15-21, wherein the layer index of the associated rectangle is less than or equal to a current layer index for the current constituent rectangle.

Clause 23. The method of any of Clauses 15-22, further comprising receiving, in the bitstream of the video data, a second constituent rectangles SEI message, receiving, in the second constituent rectangles SEI message, a second instance of the first syntax element indicating whether a second instance of the second syntax element is present in the second constituent rectangles SEI message, determining the second instance of the first syntax element indicates that the second instance of the second syntax element is absent from the second constituent rectangles SEI message, and inferring a second layer index of a second associated rectangle for a second constituent rectangle equals a current layer index for the second constituent rectangle based on the second instance of the second syntax element being absent.

Clause 24. An apparatus for decoding video data, the apparatus comprising at least one memory, and processing circuitry in communication with the at least one memory, the processing circuitry configured to receive, in a bitstream of the video data, a constituent rectangles supplemental enhancement information (SEI) message, receive, in the constituent rectangles SEI message, a first syntax element indicating whether a second syntax element is present in the constituent rectangles SEI message, in response to the first syntax element indicating the second syntax element is present, receive, in the constituent rectangles SEI message, the second syntax element, wherein the second syntax element indicates a layer index of an associated rectangle for a current constituent rectangle, and decode the video data based on the layer index of the associated rectangle.

Clause 25. The apparatus of Clause 24, wherein the processing circuitry is further configured to receive, in the constituent rectangles SEI message, a third syntax element indicating an identifier of an associated primary rectangle for the current constituent rectangle.

Clause 26. The apparatus of Clause 24, wherein the processing circuitry is further configured to determine the third syntax element is absent from the constituent rectangles SEI message, determine a reuse layout flag indicates a layout for the current constituent rectangle is reused from a reference layer, and infer the identifier of the associated primary rectangle equals a reference identifier of a reference associated primary rectangle in the reference layer based on the reuse layout flag.

Clause 27. The apparatus of Clause 25, wherein the processing circuitry is further configured to determine a length of the third syntax element based on a fourth syntax element, the fourth syntax element indicating a length parameter for rectangle identifiers.

Clause 28. The apparatus of any of Clauses 24-27, wherein to decode the video data based on the layer index of the associated rectangle, the processing circuitry is further configured to identify a layer corresponding to the layer index, identify an associated primary rectangle within the layer, and compose the current constituent rectangle and the associated primary rectangle to output a decoded picture.

Clause 29. The apparatus of any of Clauses 24-28, wherein the current constituent rectangle comprises a rectangular region within a coded picture of the video data.

Clause 30. The apparatus of any of Clauses 24-29, wherein the processing circuitry is further configured to determine the first syntax element indicates the second syntax element is absent from the constituent rectangles SEI message, and infer the layer index of the associated rectangle equals a current layer index for the current constituent rectangle based on the second syntax element being absent.

Clause 31. The apparatus of any of Clauses 24-30, wherein the layer index of the associated rectangle is less than or equal to a current layer index for the current constituent rectangle.

Clause 32. The apparatus of any of Clauses 24-31, wherein the processing circuitry is further configured to receive, in the bitstream of the video data, a second constituent rectangles SEI message, receive, in the second constituent rectangles SEI message, a second instance of the first syntax element indicating whether a second instance of the second syntax element is present in the second constituent rectangles SEI message, determine the second instance of the first syntax element indicates that the second instance of the second syntax element is absent from the second constituent rectangles SEI message, and infer a second layer index of a second associated rectangle for a second constituent rectangle equals a current layer index for the second constituent rectangle based on the second instance of the second syntax element being absent.

Clause 33. The apparatus of any of Clauses 24-32, further comprising a display configured to display decoded video data.

Clause 34. The apparatus of any of Clauses 24-33, wherein the device comprises one or more of a camera, a computer, a mobile device, a broadcast receiver device, or a set-top box.

Clause 35. A method for encoding video data, the method comprising generating, for a bitstream of the video data, a constituent rectangles supplemental enhancement information (SEI) message, generating, in the constituent rectangles SEI message, a first syntax element indicating whether a second syntax element is present in the constituent rectangles SEI message, in response to the first syntax element indicating the second syntax element is present, generating, in the constituent rectangles SEI message, the second syntax element, wherein the second syntax element indicates a layer index of an associated rectangle for a current constituent rectangle, and encoding the video data based on the layer index of the associated rectangle.

Clause 36. The method of Clause 35, further comprising generating, in the constituent rectangles SEI message, a third syntax element indicating an identifier of an associated primary rectangle for the current constituent rectangle.

Clause 37. The method of Clause 35, further comprising omitting the third syntax element from the constituent rectangles SEI message, generating a reuse layout flag indicating a layout for the current constituent rectangle is reused from a reference layer, and determining the identifier of the associated primary rectangle equals a reference identifier of a reference associated primary rectangle in the reference layer based on the reuse layout flag.

Clause 38. The method of Clause 36, further comprising generating a fourth syntax element indicating a length parameter for rectangle identifiers, and determining a length of the third syntax element based on the fourth syntax element.

Clause 39. The method of any of Clauses 35-38, wherein encoding the video data based on the layer index of the associated rectangle comprises identifying a layer corresponding to the layer index, identifying an associated primary rectangle within the layer, and composing the current constituent rectangle and the associated primary rectangle to output a reconstructed picture.

Clause 40. The method of any of Clauses 35-39, wherein the current constituent rectangle comprises a rectangular region within a coded picture of the video data.

Clause 41. The method of any of Clauses 35-40, further comprising generating the first syntax element to indicate the second syntax element is absent from the constituent rectangles SEI message, and determining the layer index of the associated rectangle equals a current layer index for the current constituent rectangle based on the second syntax element being absent.

Clause 42. The method of any of Clauses 35-41, wherein the layer index of the associated rectangle is less than or equal to a current layer index for the current constituent rectangle.

Clause 43. The method of any of Clauses 35-42, further comprising generating, for the bitstream of the video data, a second constituent rectangles SEI message, generating, in the second constituent rectangles SEI message, a second instance of the first syntax element indicating whether a second instance of the second syntax element is present in the second constituent rectangles SEI message, generating the second instance of the first syntax element to indicate that the second instance of the second syntax element is absent from the second constituent rectangles SEI message, and determining a second layer index of a second associated rectangle for a second constituent rectangle equals a current layer index for the second constituent rectangle based on the second instance of the second syntax element being absent.

Clause 44. An apparatus for encoding video data, the apparatus comprising at least one memory, and processing circuitry in communication with the at least one memory, the processing circuitry configured to generate, for a bitstream of the video data, a constituent rectangles supplemental enhancement information (SEI) message, generate, in the constituent rectangles SEI message, a first syntax element indicating whether a second syntax element is present in the constituent rectangles SEI message, in response to the first syntax element indicating the second syntax element is present, generate, in the constituent rectangles SEI message, the second syntax element, wherein the second syntax element indicates a layer index of an associated rectangle for a current constituent rectangle, and encode the video data based on the layer index of the associated rectangle.

Clause 45. The apparatus of Clause 44, wherein the processing circuitry is further configured to generate, in the constituent rectangles SEI message, a third syntax element indicating an identifier of an associated primary rectangle for the current constituent rectangle.

Clause 46. The apparatus of Clause 44, wherein the processing circuitry is further configured to omit the third syntax element from the constituent rectangles SEI message, generate a reuse layout flag indicating a layout for the current constituent rectangle is reused from a reference layer, and determine the identifier of the associated primary rectangle equals a reference identifier of a reference associated primary rectangle in the reference layer based on the reuse layout flag.

Clause 47. The apparatus of Clause 45, wherein the processing circuitry is further configured to generate a fourth syntax element indicating a length parameter for rectangle identifiers, and determine a length of the third syntax element based on the fourth syntax element.

Clause 48. The apparatus of any of Clauses 44-47, wherein to encode the video data based on the layer index of the associated rectangle, the processing circuitry is further configured to identify a layer corresponding to the layer index, identify an associated primary rectangle within the layer, and compose the current constituent rectangle and the associated primary rectangle to output a reconstructed picture.

Clause 49. The apparatus of any of Clauses 44-48, wherein the current constituent rectangle comprises a rectangular region within a coded picture of the video data.

Clause 50. The apparatus of any of Clauses 44-49, wherein the processing circuitry is further configured to generate the first syntax element to indicate the second syntax element is absent from the constituent rectangles SEI message, and determine the layer index of the associated rectangle equals a current layer index for the current constituent rectangle based on the second syntax element being absent.

Clause 51. The apparatus of any of Clauses 44-50, wherein the layer index of the associated rectangle is less than or equal to a current layer index for the current constituent rectangle.

Clause 52. The apparatus of any of Clauses 44-51, wherein the processing circuitry is further configured to generate, for the bitstream of the video data, a second constituent rectangles SEI message, generate, in the second constituent rectangles SEI message, a second instance of the first syntax element indicating whether a second instance of the second syntax element is present in the second constituent rectangles SEI message, generate the second instance of the first syntax element to indicate that the second instance of the second syntax element is absent from the second constituent rectangles SEI message, and determine a second layer index of a second associated rectangle for a second constituent rectangle equals a current layer index for the second constituent rectangle based on the second instance of the second syntax element being absent.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
receiving, in a bitstream of the video data, a constituent rectangles supplemental enhancement information (SEI) message;
receiving, in the constituent rectangles SEI message, a first syntax element indicating whether a second syntax element is present in the constituent rectangles SEI message;
in response to the first syntax element indicating the second syntax element is present, receiving, in the constituent rectangles SEI message, the second syntax element, wherein the second syntax element indicates a layer index of an associated rectangle for a current constituent rectangle; and
decoding the video data based on the layer index of the associated rectangle.

2. The method of claim 1, further comprising:
receiving, in the constituent rectangles SEI message, a third syntax element indicating an identifier of an associated primary rectangle for the current constituent rectangle.

3. The method of claim 2, further comprising:
determining the third syntax element is absent from the constituent rectangles SEI message;
determining a reuse layout flag indicates a layout for the current constituent rectangle is reused from a reference layer; and
inferring the identifier of the associated primary rectangle equals a reference identifier of a reference associated primary rectangle in the reference layer based on the reuse layout flag.

4. The method of claim 2, further comprising:
determining a length of the third syntax element based on a fourth syntax element, the fourth syntax element indicating a length parameter for rectangle identifiers.

5. The method of claim 1, wherein decoding the video data based on the layer index of the associated rectangle comprises:
identifying a layer corresponding to the layer index;
identifying an associated primary rectangle within the layer; and
composing the current constituent rectangle and the associated primary rectangle to output a decoded picture.

6. The method of claim 1, wherein the current constituent rectangle comprises a rectangular region within a coded picture of the video data.

7. The method of claim 1, further comprising:
determining the first syntax element indicates the second syntax element is absent from the constituent rectangles SEI message; and
inferring the layer index of the associated rectangle equals a current layer index for the current constituent rectangle based on the second syntax element being absent.

8. The method of claim 1, wherein the layer index of the associated rectangle is less than or equal to a current layer index for the current constituent rectangle.

9. The method of claim 1, further comprising:
receiving, in the bitstream of the video data, a second constituent rectangles SEI message;
receiving, in the second constituent rectangles SEI message, a second instance of the first syntax element indicating whether a second instance of the second syntax element is present in the second constituent rectangles SEI message;
determining the second instance of the first syntax element indicates that the second instance of the second syntax element is absent from the second constituent rectangles SEI message; and
inferring a second layer index of a second associated rectangle for a second constituent rectangle equals a current layer index for the second constituent rectangle based on the second instance of the second syntax element being absent.

10. An apparatus for decoding video data, the apparatus comprising:
at least one memory; and
processing circuitry in communication with the at least one memory, the processing circuitry configured to:
receive, in a bitstream of the video data, a constituent rectangles supplemental enhancement information (SEI) message;
receive, in the constituent rectangles SEI message, a first syntax element indicating whether a second syntax element is present in the constituent rectangles SEI message;
in response to the first syntax element indicating the second syntax element is present, receive, in the constituent rectangles SEI message, the second syntax element, wherein the second syntax element indicates a layer index of an associated rectangle for a current constituent rectangle; and
decode the video data based on the layer index of the associated rectangle.

11. The apparatus of claim 10, wherein the processing circuitry is further configured to:
receive, in the constituent rectangles SEI message, a third syntax element indicating an identifier of an associated primary rectangle for the current constituent rectangle.

12. The apparatus of claim 11, wherein the processing circuitry is further configured to:
determine the third syntax element is absent from the constituent rectangles SEI message;
determine a reuse layout flag indicates a layout for the current constituent rectangle is reused from a reference layer; and
infer the identifier of the associated primary rectangle equals a reference identifier of a reference associated primary rectangle in the reference layer based on the reuse layout flag.

13. The apparatus of claim 11, wherein the processing circuitry is further configured to:
determine a length of the third syntax element based on a fourth syntax element, the fourth syntax element indicating a length parameter for rectangle identifiers.

14. The apparatus of claim 10, wherein to decode the video data based on the layer index of the associated rectangle, the processing circuitry is further configured to:
identify a layer corresponding to the layer index;
identify an associated primary rectangle within the layer; and
compose the current constituent rectangle and the associated primary rectangle to output a decoded picture.

15. The apparatus of claim 10, wherein the current constituent rectangle comprises a rectangular region within a coded picture of the video data.

16. The apparatus of claim 10, wherein the processing circuitry is further configured to:
determine the first syntax element indicates the second syntax element is absent from the constituent rectangles SEI message; and
infer the layer index of the associated rectangle equals a current layer index for the current constituent rectangle based on the second syntax element being absent.

17. The apparatus of claim 10, wherein the layer index of the associated rectangle is less than or equal to a current layer index for the current constituent rectangle.

18. The apparatus of claim 10, wherein the processing circuitry is further configured to:
receive, in the bitstream of the video data, a second constituent rectangles SEI message;
receive, in the second constituent rectangles SEI message, a second instance of the first syntax element indicating whether a second instance of the second syntax element is present in the second constituent rectangles SEI message;
determine the second instance of the first syntax element indicates that the second instance of the second syntax element is absent from the second constituent rectangles SEI message; and
infer a second layer index of a second associated rectangle for a second constituent rectangle equals a current layer index for the second constituent rectangle based on the second instance of the second syntax element being absent.

19. The apparatus of claim 10, further comprising a display configured to display decoded video data.

20. The apparatus of claim 10, wherein the apparatus comprises one or more of a camera, a computer, a mobile device, a broadcast receiver device, or a set-top box.
